(19) United States
(12) Patent Application Publication
(10) Pub. No.: US 2026/0329865 A1
(43) Pub. Date: Oct. 22, 2026

(54) DYNAMIC CONTEXTUAL CACHING OF LARGE LANGUAGE MODEL RESULTS USING ADAPTIVE SPATIAL RELEVANCE LEARNING AND MULTI-STEP CACHE KEY CHAINING

(71) Applicant: Perforce Software, Inc., Minneapolis, MN (US)

(72) Inventors: Yoram Mizrachi, Herzeliya (IL); Rodney Cope, Bennett, CO (US)

(21) Appl. No.: 19/648,180

(22) Filed: Apr. 15, 2026

Related U.S. Application Data
(60) Provisional application No. 63/791,855, filed on Apr. 21, 2025.

(51) Int. Cl. G06F 16/2455; G06F 16/2457

(52) U.S. Cl. CPC G06F 16/24552; G06F 16/24578

(57) ABSTRACT

A dynamic contextual caching system for large language model (LLM) outputs can decompose input images into grids of spatial regions and compute perceptual fingerprints for each region. A bidirectional relevance determination mechanism can combine bottom-up adaptive spatial relevance learning with top-down response-driven forced relevancy that analyzes LLM response content to pin conditionally relevant regions. A multi-step cache key chaining system derives stable uniqueness identifiers (e.g., a Canonicalized Answer Identifier from response content and a Visual Screen Signature from input imagery) and uses these as priority-ordered alternate cache lookup keys via an alias table, enabling cross-step cache reuse in sequential workflows that is resilient to superficial variations in intermediate outputs. Semantic equivalence of responses can be determined through a tiered validation architecture employing a fast primary similarity model and for some ambiguous cases a more accurate secondary model.

### CROSS-REFERENCE TO RELATED APPLICATION

This application claims priority to, and the benefit of, U.S. Provisional Patent Application No. 63/791,855, filed on Apr. 21, 2025, entitled “Contextual Semantics for Testing,” the entire contents of which are hereby incorporated by reference. In addition, this application is related to the same applicant's concurrently filed and co-pending U.S. Patent Application entitled “Autonomous, Context-Aware, Event-Driven Software Testing Using Natural Language Scenario Abstraction and Progressive Human-in-the-Loop Delegation,” the entire contents of which are hereby incorporated by reference.

### TECHNICAL FIELD

Embodiments disclosed herein relate generally to systems and methods for caching computational results from large language models (LLMs), and more particularly to a dynamic contextual caching system that employs adaptive spatial relevance learning, multi-step cache key chaining, and tiered semantic validation to intelligently determine when cached LLM results may be reused despite superficial changes in multimodal input contexts.

### BACKGROUND

Large language models (LLMs) have become integral to a wide range of applications, from natural language processing and conversational AI to automated software testing and quality assurance. These models process textual prompts and multimodal contexts—including images, structured data, and metadata—to produce intelligent responses. However, LLM inference is computationally expensive, involving billions of parameters and significant processing time, energy consumption, and monetary cost per invocation.

Traditional caching mechanisms operate on the assumption that identical requests yield identical responses. Web caching systems rely on exact URL matching with timestamp or ETag-based validation. Computation caching stores input-output mappings keyed on exact input hash matches. These approaches fail in the LLM context because requests often include multimodal contexts that contain dynamically changing elements—such as timestamps, status bar icons, UI styling variations, notification badges, or battery indicators—that do not materially affect the LLM's semantic response.

In the specific domain of automated software testing using AI agents, the problem is particularly acute. AI-driven test execution systems capture screenshots of application interfaces at each test step and submit these screenshots along with natural language instructions to an LLM for interpretation and action planning. The same application screen may appear with different transient UI elements across test runs, causing complete cache misses despite the semantic equivalence of the visual content.

A further challenge arises in multi-step sequential workflows. In such workflows, the cache key for step N naturally depends on the context from step N−1. If the prior step produces a result that is semantically identical but textually or visually slightly different (e.g., a timestamp in the response, a minor layout shift in a screenshot), the downstream cache key changes entirely, creating a cascade of cache misses across the entire workflow chain. No existing caching approach addresses this multi-step dependency problem.

Existing approaches to semantic caching—such as embedding-based similarity search over prompts—fail to adequately address the multimodal nature of modern LLM inputs. They do not account for the spatial structure of visual contexts, cannot learn which regions of an image are relevant versus irrelevant to producing a particular response, and lack mechanisms for cross-step optimization in multi-step workflows.

Accordingly, there is a need for a caching system that can: (1) intelligently distinguish between relevant and irrelevant portions of multimodal LLM input contexts; (2) learn from repeated interactions which context changes are immaterial; (3) enable efficient cache reuse across related steps in sequential workflows through stable uniqueness identifiers derived from prior step outputs; and (4) employ tiered validation strategies that balance speed and accuracy for semantic equivalence determination.

### SUMMARY

The present invention provides a system, method, and non-transitory computer-readable medium for dynamic contextual caching of large language model results. The invention addresses the fundamental problem of cache inefficiency when LLM inputs contain multimodal contexts with dynamically changing but semantically irrelevant elements, and when multi-step workflows create cascading cache miss chains.

In one aspect, the invention provides a method comprising: receiving a prompt and a multimodal context; decomposing visual context into a grid of spatial regions; computing a perceptual fingerprint for each region; searching a cache store using a priority-ordered sequence of cache key variants derived from stable uniqueness identifiers of previous step outputs; comparing input region fingerprints against cached region fingerprints while applying learned irrelevance masks that exclude regions previously determined to be irrelevant to the LLM response; and returning the cached result when matching criteria are satisfied.

In another aspect, the invention provides an adaptive spatial relevance learning mechanism that automatically discovers which spatial regions of visual contexts are immaterial to producing a particular LLM response. When the system observes that a region's visual content changes without affecting the semantic response, it incrementally increases that region's irrelevance score. Over time, regions that consistently change without consequence—such as those displaying clocks, battery indicators, or notification badges—are automatically excluded from future matching, progressively improving cache hit rates without manual configuration.

In yet another aspect, the invention provides a multi-step cache key chaining system that enables cross-step cache optimization in sequential workflows. The system derives stable uniqueness identifiers from each step's outputs—a canonicalized semantic identifier from the response content, and a visual signature from the input image—and uses these as alternate cache lookup keys for subsequent steps. This creates a chain of stable references that are resilient to superficial variations, enabling cache hits across workflow runs even when intermediate steps produce slightly different but semantically equivalent outputs.

In a still further aspect, the invention provides a bidirectional relevance determination mechanism. While the adaptive spatial relevance learning operates bottom-up—discovering irrelevance through statistical observation of visual changes that do not affect responses—a complementary response-driven forced relevancy mechanism operates top-down, analyzing the content of LLM responses to identify spatial regions that must remain relevant regardless of statistical evidence. When a response references specific coordinates, bounding regions, or named UI elements, the system pins the corresponding spatial tiles as permanently relevant, preventing the irrelevance learning mechanism from incorrectly marking them as irrelevant. This bidirectional approach resolves a fundamental limitation of purely observation-based irrelevance learning: the inability to distinguish between regions that are always irrelevant and regions that are conditionally relevant depending on the specific query.

In a further aspect, the invention provides a tiered semantic validation architecture for determining response equivalence. A lightweight, computationally efficient similarity model provides fast primary scoring. Clear matches and clear mismatches are resolved immediately. Ambiguous results in a defined “grey zone” are escalated to a more computationally expensive but more accurate secondary validation model. This tiered approach provides an optimal balance of speed and accuracy while minimizing false cache hits and false cache misses.

### BRIEF DESCRIPTION OF THE DRAWINGS

FIG. 1 is a block diagram illustrating an exemplary system architecture for an embodiment of an overall contextual caching system, including the main backend, cache service, storage layer, fingerprinting, and semantic model components.

FIG. 2 is a flow diagram illustrating an exemplary cache lookup (GET) process, including cache key variant generation, region fingerprint matching with irrelevance masking, and semantic validation.

FIG. 3 is a flow diagram illustrating an exemplary cache update process, including fingerprint computation, semantic matching, irrelevance learning, and alias creation.

FIG. 4 is a flow diagram illustrating an exemplary spatial region-based image fingerprinting process, including grid decomposition, perceptual hash generation, and metadata extraction.

FIG. 5 is a flow diagram illustrating an exemplary adaptive spatial relevance learning mechanism, including showing how region irrelevance scores evolve over successive cache interactions.

FIG. 6 is a block diagram illustrating an exemplary embodiment of a multi-step cache key chaining system, showing the relationship between base keys, canonicalized answer identifiers, visual signature identifiers, and alias resolution.

FIG. 7 is a flow diagram illustrating an exemplary tiered semantic validation process, including primary scoring, grey zone detection, and secondary validation.

FIG. 8 is a block diagram illustrating a process for position-aware coordinate matching with normalized coordinate space for resolution-independent UI element matching.

FIG. 9 is a block diagram illustrating an exemplary embodiment of response-driven forced relevancy mechanism, showing how LLM response content can be analyzed to pin spatial regions as permanently relevant, which can help to prevent instances of incorrect irrelevance learning for conditionally relevant regions.

### DETAILED DESCRIPTION

The following detailed description sets forth specific embodiments of the present invention. It should be understood that the invention is not limited to the particular embodiments described herein but encompasses all modifications, equivalents, and alternatives falling within the spirit and scope of the appended claims.

### I. System Architecture Overview

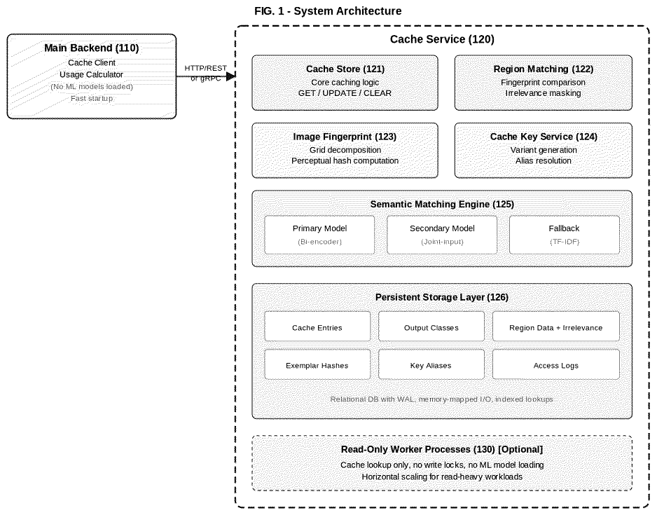

Referring now to FIG. 1, the contextual caching system 100 comprises a main backend module 110 and a cache service module 120 that communicate via a network interface. This architectural separation ensures that computationally expensive machine learning models required by the cache service are loaded only in the cache service process, while the main backend remains lightweight with fast startup times. In a preferred embodiment, the communication occurs via HTTP/REST, though alternative transport protocols such as gRPC may be employed.

The cache service module 120 further comprises: a cache store component 121 implementing the core caching logic; a region matching service 122 for visual fingerprint comparison with irrelevance masking; an image fingerprint service 123 for computing region-based perceptual hashes; a cache key service 124 for generating and resolving cache key variants and aliases; a semantic matching engine 125 comprising primary and secondary validation models; and a persistent storage layer 126. One or more optional read-only worker processes 130 may handle cache lookup operations for horizontal scaling of read-heavy workloads.

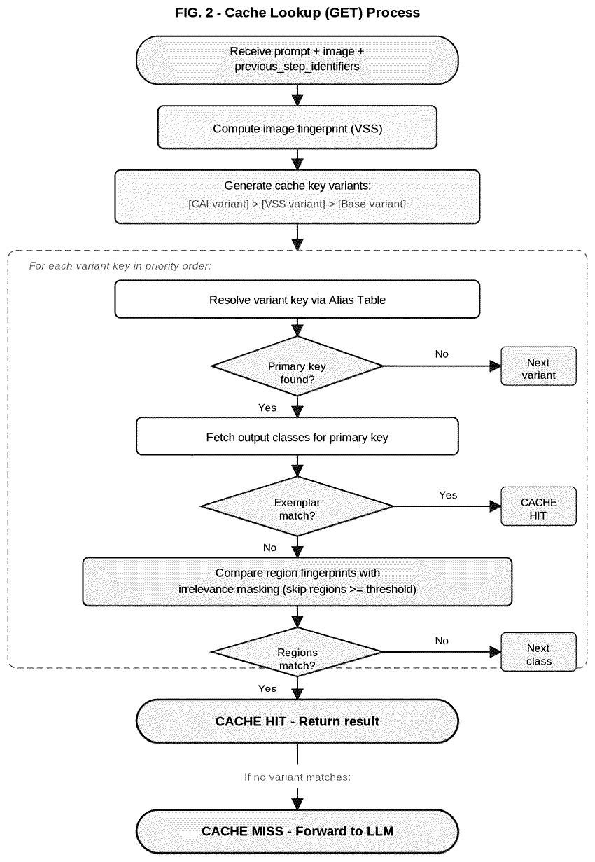

Referring now to FIG. 2, the cache lookup (GET) process begins with the generation of cache key variants from the prompt and any available stable uniqueness identifiers from preceding workflow steps. The variants are searched in priority order through the alias table to resolve to primary cache keys. For each resolved key, the system retrieves cached entries and performs region fingerprint matching with irrelevance masking. When a matching entry is found, semantic validation confirms the match before returning the cached result.

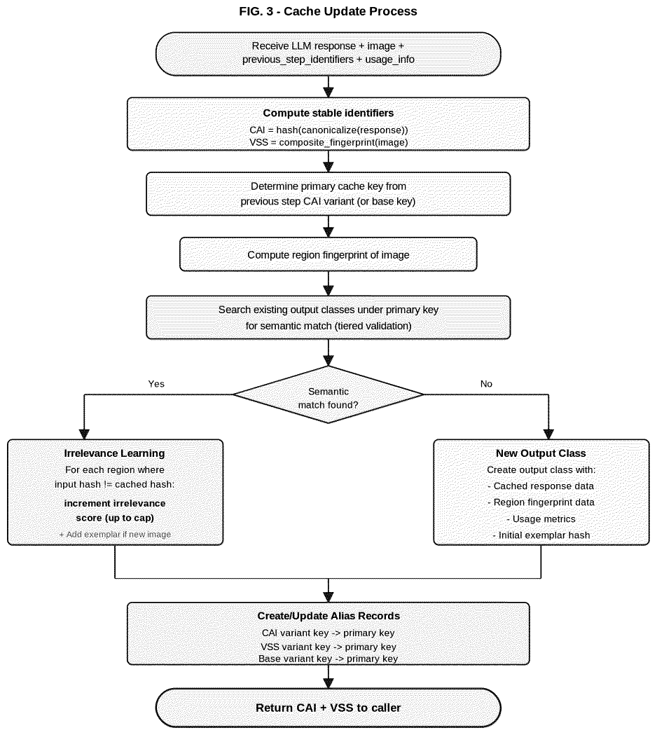

Referring now to FIG. 3, the cache update process accepts a new LLM response along with its associated image context. The system computes a structured fingerprint for the input image, determines semantic equivalence with existing cached entries using the tiered validation described in Section V, learns irrelevance information from visual differences between the new and cached fingerprints, creates alias records for multi-step chaining, and stores or updates the cache entry with the new response data and fingerprint.

### II. Spatial Region-Based Image Fingerprinting

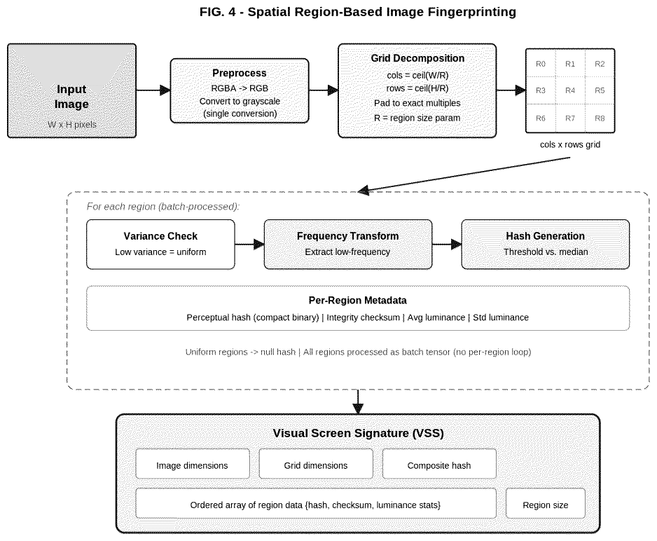

Referring now to FIG. 4, the image fingerprinting system decomposes an input image into a grid of spatial regions and computes a perceptual fingerprint for each region. The fingerprinting captures the essential visual structure of each region in a compact representation that is robust to minor pixel-level variations while remaining sensitive to meaningful visual differences.

### A. Image Preprocessing and Grid Decomposition

Upon receiving an input image, the system converts it to a standardized format (e.g., converting multi-channel images to a single-channel grayscale representation). The system then computes grid dimensions based on the image size and a configurable region size parameter. For an image of width W and height H with region size R, the grid contains ceil(W/R) columns and ceil(H/R) rows. The image is padded to exact grid multiples, ensuring all regions are uniformly sized. Each region corresponds to a localized spatial area of the image that can be independently evaluated for relevance.

### B. Perceptual Hash Computation

For each region in the grid, the system computes a perceptual hash—a compact fixed-length identifier that represents the visual content of the region. The perceptual hash is designed such that visually similar regions produce identical or nearly identical hashes, while visually distinct regions produce different hashes. In a preferred embodiment, the system employs a frequency-domain analysis technique: each region is transformed into a frequency representation (e.g., via a discrete cosine transform), low-frequency components are extracted to capture the essential spatial structure, and a binary hash is generated by thresholding the frequency coefficients against a central value such as the median. The resulting hash is a compact binary string (e.g., 64 bits packed into a hexadecimal representation). Regions with negligible visual information (e.g., uniform color areas) are identified by measuring the statistical variance of pixel values and assigned a null hash.

In a preferred embodiment, the fingerprinting process is optimized through batch processing—all regions are processed simultaneously as a single tensor operation rather than iteratively, significantly reducing computation time. The system may also employ a compiled native extension that releases language runtime locks during computation, enabling true parallel fingerprinting on multi-core systems, with a transparent fallback to an interpreted implementation.

### C. Composite Fingerprint and Metadata

The complete fingerprint for an image comprises: the image dimensions; a composite perceptual hash derived from all region hashes; the grid dimensions; an ordered array of region data objects each containing the region's perceptual hash, integrity checksum, and luminance statistics; and the region size parameter. This structured fingerprint is designated herein as the Visual Screen Signature (VSS). Per-region luminance statistics (average and standard deviation) are retained for potential adaptive threshold capabilities in future matching.

### III. Adaptive Spatial Relevance Learning

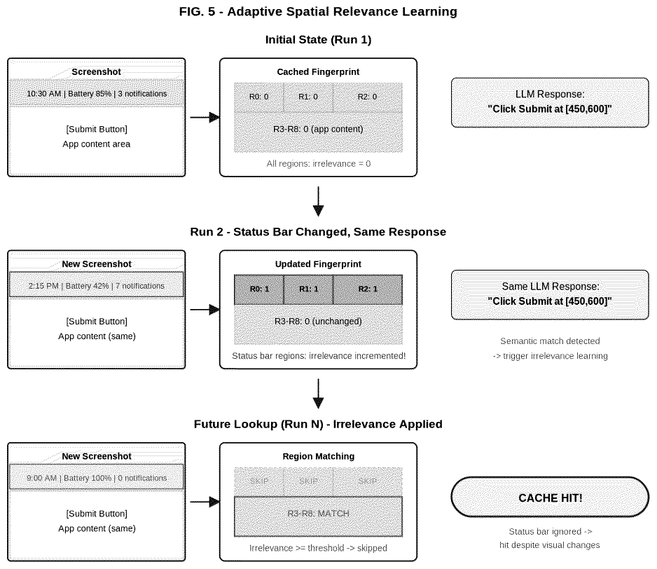

Referring now to FIG. 5, the adaptive spatial relevance learning mechanism automatically discovers which spatial regions of visual contexts are immaterial to producing a particular LLM response. Unlike prior art systems that require manual specification of relevant/irrelevant context portions, this mechanism learns relevance autonomously through observation of cache interactions over time.

### A. Initial State

When a new cache entry is created, all regions in the associated fingerprint are initialized with an irrelevance score of zero, indicating that all spatial regions are presumed relevant.

### B. Irrelevance Discovery Through Observation

When the cache system receives a new LLM response that is determined to be semantically equivalent to an existing cached response (via the tiered semantic validation described in Section V), the system compares the new input image fingerprint against the cached fingerprint on a region-by-region basis. For each region position where the input perceptual hash differs from the cached perceptual hash, the system increments the irrelevance score for that region position, up to a configurable maximum cap (e.g., 10). This indicates that the visual content at that spatial position changed without affecting the semantic response, providing empirical evidence that the region is irrelevant to the LLM's output.

For example, consider an application under test that displays a status bar with a clock, battery icon, and notification count. Across multiple test runs, the clock time, battery level, and notification count change, but the LLM's response—identifying a button to click—remains the same. The system observes that the regions corresponding to the status bar consistently differ without consequence, and their irrelevance scores increase toward the cap. Meanwhile, the region containing the target button maintains an irrelevance score of zero because its visual appearance correlates with the response.

### C. Irrelevance Application During Cache Lookup

During cache lookup operations, the region matching process accepts a configurable strength parameter that serves as the irrelevance threshold. When comparing input regions against cached regions, any cached region whose irrelevance score meets or exceeds the strength threshold is automatically skipped—its visual content is not compared. Only regions with irrelevance scores below the threshold are subject to perceptual hash comparison. This enables the system to progressively become more tolerant of visual changes in regions that have been empirically determined to be irrelevant, improving cache hit rates over time without any manual configuration or annotation.

### D. Exemplar Fast Path

The system maintains a set of exemplar fingerprints for each cached response class. These are composite perceptual hashes from images that have previously been associated with the same semantic response. During region matching, the system first checks whether the input image's composite perceptual hash matches any exemplar in the set. If an exact exemplar match is found, the system immediately returns a cache hit without performing region-by-region comparison, providing a computationally efficient fast path for previously seen images.

### E. Response-Driven Forced Relevancy

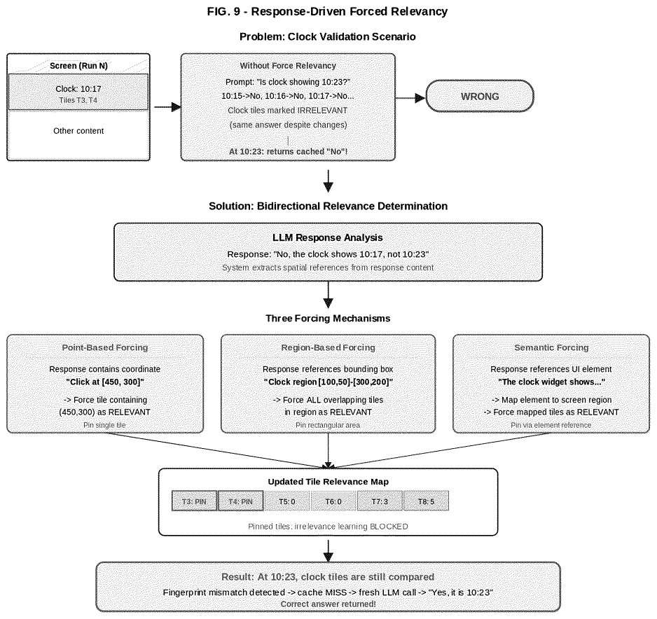

Referring now to FIG. 9, the adaptive spatial relevance learning mechanism described above operates through bottom-up statistical observation: when a region changes without affecting the response, its irrelevance score increases. However, purely observation-based irrelevance learning has a fundamental limitation when dealing with conditionally relevant regions—regions whose content is relevant to the response only under certain circumstances.

Consider a scenario where an LLM is asked to determine whether a clock on screen displays a specific time, such as “Is the clock showing 10:23?” During successive evaluations at times 10:15, 10:16, 10:17, and so forth, the LLM response remains “No” despite the clock's visual appearance changing at each evaluation. From the perspective of pure irrelevance learning, the clock regions satisfy the criterion for irrelevance: they change without affecting the response. Over time, the system would mark the clock tiles as irrelevant. However, when the clock reaches 10:23, the correct response should change to “Yes.” Because the clock tiles have been marked irrelevant, the system skips them during matching, returns the cached “No” response, and produces an incorrect result.

To address this, the invention provides a response-driven forced relevancy mechanism that analyzes the content of LLM responses to identify spatial regions that must remain relevant. This mechanism operates top-down—from the response back to the input spatial regions—complementing the bottom-up irrelevance learning to form a bidirectional relevance determination system.

The forced relevancy mechanism can support the following three types of spatial reference extraction from response content:
Point-Based Forcing: When an LLM response contains coordinate references (e.g., “Click at [450, 300]”), the system identifies the spatial tile or tiles that contain the referenced coordinates and marks them as force-relevant. The tile's irrelevance score is pinned, preventing the irrelevance learning mechanism from incrementing it regardless of future observations. This ensures that the visual content at an action target location is always compared during cache lookup.
Region-Based Forcing: When an LLM response references a bounding region defined by corner coordinates (e.g., a rectangular area from [100, 50] to [300, 200]), the system identifies all spatial tiles that overlap with the referenced bounding box and marks each as force-relevant. This is particularly applicable when the response describes an area of interest, such as “the clock region at [100, 50] to [300, 200] shows 10:17.” All tiles intersecting this region are pinned as relevant.
Semantic Element Forcing: When an LLM response references a named UI element (e.g., “the clock widget,” “the search bar,” or “the notification panel”), the system maps the element reference to a screen region using available element location metadata (e.g., accessibility trees, UI element coordinates, or OCR-detected text regions) and marks the corresponding tiles as force-relevant. This enables relevance pinning even when the response does not contain explicit coordinates.

The forced relevancy mechanism can integrate with the existing irrelevance learning system as follows: when a tile is marked as force-relevant, its irrelevance score is effectively frozen at zero or reset to zero if it had previously accumulated irrelevance. During cache lookup, force-relevant tiles are always included in the region-by-region comparison, regardless of the configured irrelevance threshold. This ensures that the cache system correctly detects visual changes in regions that the LLM has identified as meaningful to its response.

Returning to the clock validation example: when the LLM responds “No, the clock shows 10:17, not 10:23” and references the clock's spatial location, the system pins the clock tiles as force-relevant. In subsequent evaluations, even though the response continues to be “No” while the clock changes, the clock tiles are never marked as irrelevant because their forced relevancy status takes precedence over the bottom-up irrelevance learning. When the clock reaches 10:23, the system correctly detects the visual change in the clock tiles, the cached fingerprint does not match, and a fresh LLM call produces the correct “Yes” response.

### IV. Multi-Step Cache Key Chaining

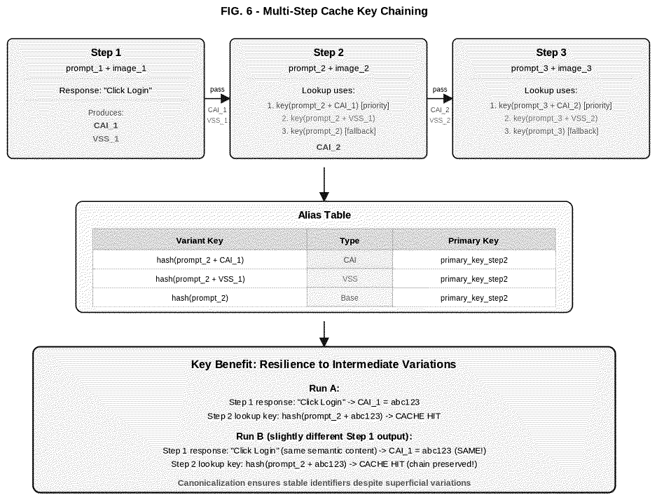

Referring now to FIG. 6, the multi-step cache key chaining system enables cross-step cache optimization in sequential workflows. This addresses a fundamental problem in multi-step LLM interactions: when the cache key for step N depends on the context from step N-1, even trivial variations in intermediate outputs create cascading cache misses throughout the workflow. The invention solves this by deriving stable uniqueness identifiers from each step's outputs and using these as alternate cache lookup keys.

### A. Stable Uniqueness Identifiers

The system can define two following types of stable uniqueness identifiers derived from step outputs:
Canonicalized Answer Identifier (CAI): A deterministic hash computed from a canonicalized (e.g., sorted, normalized) representation of the step's response content. Because the canonicalization normalizes irrelevant variations (e.g., key ordering in JSON, whitespace), two semantically equivalent responses produce the same CAI even if their raw representations differ slightly. In a preferred embodiment, the system computes a SHA-256 hash of the sorted JSON representation of the response data. The CAI captures the semantic identity of a step's output and serves as the primary chaining identifier.
Visual Screen Signature (VSS): The composite perceptual hash from the step's input image fingerprint, as described in Section II. The VSS captures the visual identity of what the system “saw” at a given step and serves as the secondary chaining identifier.

### B. Cache Key Variant Generation

For each cache operation, the system generates multiple cache key variants by combining the base cache key (derived from the prompt data) with each stable identifier from the previous step. This can produce a priority-ordered set of variant keys such as follows:
CAI Variant (highest priority): Combines the base key with the previous step's Canonicalized Answer Identifier. This variant enables cache hits when the previous step produced the same semantic answer, regardless of visual presentation.
VSS Variant (second priority): Combines the base key with the previous step's Visual Screen Signature. This variant enables cache hits when the previous step saw the same visual screen, regardless of response text.
Base Key Variant (fallback): Uses the base key alone without any previous step context. This provides a fallback when no previous step information is available.

### C. Alias Table and Resolution

The system maintains an alias table that maps variant keys to primary cache keys. When a cache entry is created or updated, the system creates alias records linking the generated CAI, VSS, and base variant keys to the primary cache key under which the entry is stored. During lookup, the system queries variant keys in priority order, resolves each through the alias table to locate the primary cache key, and searches for matching entries under the resolved key. This two-level indirection (variant→alias→primary key→entries) enables flexible cross-step reuse without duplicating cache entries.

### D. Chaining Across Workflow Steps

After each cache interaction (whether a hit or a miss followed by LLM invocation), the system returns the current step's CAI and VSS to the caller. The caller stores these identifiers and passes them as the “previous step variants” when invoking the cache for the next step. This creates a chain of stable references across the workflow:
Step 1: prompt_1+image_1→response_1, CAI_1, VSS_1
Step 2: prompt_2+image_2+[CAI_1, VSS_1]→lookup via CAI variant first, then VSS variant, then base
Step 3: prompt_3+image_3+[CAI_2, VSS_2]→lookup via CAI variant first, then VSS variant, then base

Because CAI and VSS are derived from the semantic and visual content of each step (rather than from raw bytes or arbitrary identifiers), they remain stable across workflow runs as long as the underlying content is equivalent. This effectively breaks the cascading cache miss problem: even if step 1 produces a slightly different raw response in a new run, its CAI will be the same if the semantic content matches, enabling step 2 to still find a cache hit.

### V. Tiered Semantic Validation

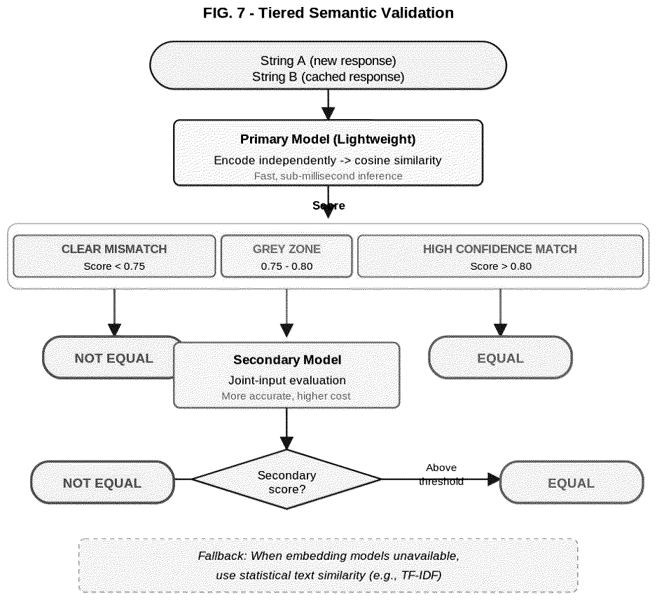

Referring now to FIG. 7, the system employs a tiered semantic validation architecture to determine whether two LLM responses are semantically equivalent. This validation is critical for the irrelevance learning mechanism (Section III) and for preventing duplicate cache entries with semantically identical content.

### A. Field-by-Field Recursive Matching

The response matching algorithm operates recursively on the structured representation of LLM responses. For each field in the response, the algorithm applies type-specific comparison logic: string values are compared using semantic similarity; numeric values are compared with configurable tolerance; boolean values require exact match; arrays are compared element-wise with support for position-aware coordinate matching (described in Section VI); and nested objects are compared recursively.

### B. Primary Scoring With Lightweight Embedding Model

For string field comparison, the system computes a semantic similarity score using a lightweight embedding model optimized for fast inference. The system encodes both strings into dense vector embeddings and computes a distance metric (e.g., cosine similarity) between them. In a preferred embodiment, the system uses a compact sentence transformer model (e.g., from the MiniLM family) that provides sub-millisecond encoding times while maintaining sufficient semantic discrimination. The system further supports adaptive model selection based on detected language, switching between a language-specific model for the dominant language of use and a multilingual model for other languages.

### C. Three-Tier Decision Logic

The primary similarity score can be evaluated against a three-tier decision framework such as follows:
High Confidence Match (score above upper threshold): The strings are deemed semantically equivalent. No further validation is required. In a preferred embodiment, the upper threshold is 0.80.
Clear Mismatch (score below lower threshold): The strings are deemed semantically different. The comparison fails. In a preferred embodiment, the lower threshold is 0.75.
Grey Zone (score between thresholds): The result is ambiguous and requires secondary validation. This zone is intentionally narrow to minimize the computational overhead of secondary validation while capturing genuinely ambiguous cases.

### D. Secondary Validation With Joint-Input Model

When a comparison falls within the grey zone, the system invokes a secondary validation model that processes both strings jointly—evaluating them as a pair rather than encoding them independently. This joint-input architecture (commonly known as a cross-encoder) provides more accurate similarity judgments for ambiguous cases because it can attend to fine-grained interactions between the two texts. The secondary score is normalized and compared against a secondary threshold to make the final determination. In a preferred embodiment, the secondary model is a compact reranking model, and the secondary threshold is 0.52 after sigmoid normalization.

### E. Fallback for Resource-Constrained Environments

When neural embedding models are unavailable (e.g., in lightweight read-only worker processes), the system falls back to a statistical text similarity method such as TF-IDF vectorization with cosine similarity, ensuring degraded but functional cache matching.

### VI. Position-Aware Coordinate Matching

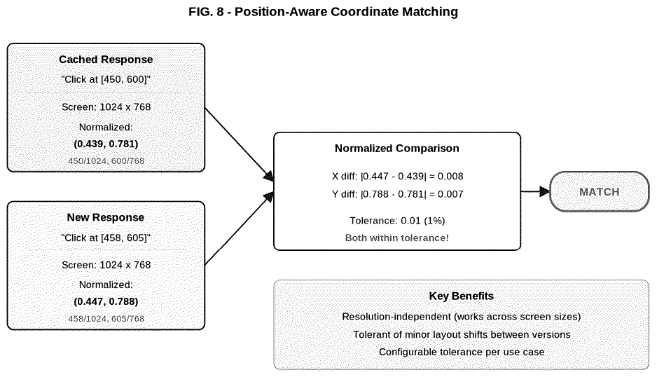

Referring now to FIG. 8, the system provides specialized handling for LLM responses that contain coordinate values (e.g., click positions on a user interface). The system normalizes raw pixel coordinates to a zero-to-one range using the screen dimensions, then compares normalized coordinates with a configurable tolerance parameter. This enables cache hits for responses that specify UI element positions even when slight layout shifts occur between application versions, provided the positions remain within the specified tolerance. The normalization ensures resolution-independent matching across different screen sizes and device form factors.

The system discriminates coordinate fields from other array types using helper metadata that annotates specific response fields as position data. When position metadata is present, the system applies the normalized coordinate comparison; otherwise, standard field-by-field comparison is used.

### VII. Storage Architecture

The persistent storage layer maintains the cache entries, region fingerprints, irrelevance scores, exemplar hashes, and alias mappings in a relational database. In a preferred embodiment, the system employs SQLite configured with Write-Ahead Logging (WAL) for concurrent read access, memory-mapped I/O for efficient data retrieval, and indexed lookups on cache keys, response hashes, region perceptual hashes, and alias mappings.

The storage schema can include the following primary entities:
Cache Entries: Primary cache key metadata including creation and last-served timestamps, response hashes, and serving counters within a rolling time window (e.g., 30 days) for popularity analysis.
Output Classes: Response variants for each cache key, each storing the cached response data, Visual Screen Signature, usage metrics, and serving analytics. A single cache entry may have multiple output classes representing different valid responses for the same prompt and context.
Region Data: Per-region fingerprint data for each output class, including the perceptual hash, integrity checksum, luminance statistics, and the learned irrelevance score.
Exemplar Hashes: Composite perceptual hashes from images previously associated with each output class, enabling the exemplar fast-path matching.
Cache Key Aliases: Mapping from variant keys (CAI, VSS, base) to primary cache keys for the multi-step chaining alias resolution system.
Access Logs: Rolling-window access logging with configurable retention periods for serving analytics and cache optimization decisions.

### VIII. Usage Metrics and Sustainability Tracking

The system can track comprehensive usage metrics for each cache operation, including token counts (input and output), processing time, monetary cost, and environmental impact. Cost calculations use model-specific per-token pricing configurations, while environmental impact calculations convert computational energy consumption (joules per token, configured per model and provider) to CO2 equivalent emissions using regional grid intensity factors. When a cache hit occurs, the system computes the savings—the avoided tokens, cost, time, and carbon emissions—and returns these metrics alongside the cached result, enabling organizations to quantify the operational and environmental benefits of the caching system.

### IX. Concurrency and Scaling Architecture

The system can support horizontal scaling through an architecture that separates read and write operations. For read-heavy workloads, optional read-only worker processes handle cache lookup operations without acquiring write locks, as the storage layer's concurrent-read mode permits safe parallel reads. Write operations (cache updates) are serialized to ensure consistency. Fingerprint computation, being computationally intensive, is performed outside write-critical sections to maximize parallelism. The system supports multiple transport protocols (e.g., HTTP/REST and gRPC) to accommodate diverse deployment configurations.

What is claimed is:

1. A computer-implemented method for contextual caching of large language model (LLM) results, the method comprising:
(a) receiving, by a computing system, a prompt and a context comprising at least one image;
(b) decomposing the image into a grid of spatial regions and computing a perceptual fingerprint for each spatial region, producing a structured fingerprint comprising an ordered set of per-region perceptual hashes;
(c) generating a plurality of cache key variants from the prompt and from one or more stable uniqueness identifiers that are derived from a preceding workflow step, and searching the cache key variants in a defined priority order;
(d) for each cache key variant, resolving the variant to a primary cache key through an alias table, and retrieving cached entries associated with the resolved primary key;
(e) comparing the per-region perceptual hashes of the input fingerprint against per-region perceptual hashes of a cached entry while applying a learned irrelevance mask, wherein spatial regions having an irrelevance score at or above a threshold are excluded from comparison;
(f) upon finding a matching cached entry, returning the cached LLM result; and
(g) upon finding no matching cached entry, transmitting the prompt and context to an LLM for processing.

2. The method of claim 1, further comprising performing adaptive spatial relevance learning, comprising: upon receiving a new LLM response that is semantically equivalent to a cached response, comparing per-region perceptual hashes of the input fingerprint against per-region perceptual hashes of the cached entry; for each region position where the hashes differ, incrementing an irrelevance score associated with that region; whereby regions whose visual content changes across interactions without affecting the LLM response progressively accumulate irrelevance scores and are automatically excluded from future comparisons.

3. The method of claim 1, wherein the stable uniqueness identifiers comprise: a Canonicalized Answer Identifier (CAI) derived from a deterministic hash of a normalized representation of response content of the preceding workflow step; and a Visual Screen Signature (VSS) derived from a composite perceptual hash of an input image of the preceding workflow step; and wherein the priority order for cache key variants is: CAI variant first, VSS variant second, and a base key variant derived from the prompt alone as a fallback.

4. The method of claim 3, further comprising: upon storing a new cache entry, creating alias records in the alias table mapping each of the CAI variant key, VSS variant key, and base variant key to the primary cache key; and after each cache interaction, returning the current step's CAI and VSS to the caller for use as previous step identifiers in a subsequent step, thereby creating a chain of stable references across sequential workflow steps that is resilient to superficial variations in intermediate outputs.

5. The method of claim 1, wherein determining semantic equivalence of LLM responses comprises a tiered semantic validation process comprising: computing a primary similarity score using a first computational model; if the primary score exceeds an upper threshold, determining semantic equivalence; if the primary score falls below a lower threshold, determining semantic non-equivalence; if the primary score falls within a grey zone between the upper and lower thresholds, invoking a second computational model that evaluates both responses jointly for secondary validation; and determining semantic equivalence based on the secondary score.

6. The method of claim 5, wherein the tiered semantic validation further comprises adaptive model selection, wherein the system detects the language of the response text and selects between a language-specific model pair and a multilingual model pair for the first and second computational models.

7. The method of claim 5, wherein the tiered semantic validation is applied recursively on a field-by-field basis to structured response data, with type-specific comparison logic comprising: semantic similarity for string values, tolerance-based comparison for numeric values, exact matching for boolean values, position-aware comparison for coordinate arrays, and recursive application for nested objects.

8. The method of claim 1, further comprising maintaining a set of exemplar composite fingerprints for each cached response class, and during comparison, first checking whether the input image's composite perceptual hash matches any exemplar, and upon finding an exact exemplar match, returning a cache hit without performing region-by-region comparison.

9. The method of claim 1, further comprising position-aware coordinate matching for LLM responses containing spatial coordinate values, comprising: normalizing coordinate values to a resolution-independent range using context dimensions; comparing normalized coordinates with a configurable tolerance; and determining a match when coordinate differences fall within the tolerance.

10. The method of claim 1, wherein a single cache key is associated with a plurality of output classes, each representing a distinct semantically valid response for the same prompt and context, and wherein the cache lookup evaluates each output class for region fingerprint matching independently.

11. The method of claim 1, further comprising computing and returning usage savings metrics upon a cache hit, comprising at least: avoided token consumption, avoided monetary cost, avoided processing time, and avoided environmental emissions, computed using model-specific cost and energy consumption configurations.

12. The method of claim 2, wherein the irrelevance score for each region is bounded by a configurable maximum cap, and wherein the threshold for excluding regions during comparison is independently configurable, enabling fine-grained control over the trade-off between cache hit rate and matching precision.

13. The method of claim 2, further comprising response-driven forced relevancy, comprising: analyzing content of an LLM response to identify spatial references within the response; mapping identified spatial references to one or more spatial regions in the grid; and marking the mapped regions as force-relevant, wherein force-relevant regions are excluded from irrelevance score incrementing and are always included in region-by-region comparison during cache lookup regardless of the irrelevance threshold.

14. The method of claim 13, wherein the spatial references comprise one or more of: point-based references specifying coordinate positions within the image, wherein the system identifies spatial regions containing the specified coordinates; region-based references specifying bounding areas defined by corner coordinates, wherein the system identifies all spatial regions overlapping the bounding area; and semantic element references specifying named interface elements, wherein the system maps element names to screen regions using element location metadata.

15. The method of claim 13, wherein the adaptive spatial relevance learning and the response-driven forced relevancy together form a bidirectional relevance determination system, wherein: the adaptive spatial relevance learning operates bottom-up by statistically observing which regions change without affecting responses; and the forced relevancy operates top-down by analyzing response content to identify regions that must remain relevant; and wherein forced relevancy takes precedence over statistical irrelevance evidence, preventing incorrect irrelevance marking for regions that are conditionally relevant depending on the specific query.

16. A system for contextual caching of large language model results, the system comprising: one or more programmable processors; and memory storing non-transitory computer readable instructions that, when executed, cause the system to:
(a) maintain a cache store comprising cache entries, each entry associating a primary cache key with one or more output classes, each output class storing a cached LLM response and a structured fingerprint comprising per-region perceptual hashes with associated learned irrelevance scores;
(b) upon receiving a cache lookup request comprising a prompt, an image, and zero or more stable uniqueness identifiers from a preceding workflow step, generate a priority-ordered set of cache key variants, resolve each variant through an alias table to a primary cache key, and search for matching entries;
(c) compare per-region perceptual hashes of the input image against cached per-region hashes while excluding regions whose learned irrelevance scores meet or exceed a configurable threshold;
(d) upon receiving a cache update with a new LLM response, determine semantic equivalence with existing cached responses using a tiered validation comprising a primary similarity model and a secondary joint-input validation model for ambiguous cases; and
(e) when semantic equivalence is found with differing visual content, increment irrelevance scores on regions whose perceptual hashes differ, thereby progressively learning which spatial regions are immaterial to the LLM response.

17. The system of claim 16, further configured to derive, from each cache interaction, a Canonicalized Answer Identifier from the response content and a Visual Screen Signature from the input image, return these identifiers to the caller, and use identifiers received from one or more prior steps to generate cache key variants that enable cross-step cache reuse in multi-step sequential workflows.

18. The system of claim 16, further comprising an exemplar store maintaining composite perceptual hashes for each output class, enabling a fast-path cache hit when an input image composite hash exactly matches a stored exemplar without requiring region-by-region comparison.

19. The system of claim 16, wherein the cache store and semantic validation models are hosted in a separate service process from a main application backend, such that the main backend communicates with the cache service via a network interface and does not load semantic validation models, and wherein the cache service optionally spawns read-only worker processes for cache lookup operations that operate without write serialization.

20. The system of claim 16, further comprising rolling-window access logging with configurable retention periods, maintaining per-entry and per-output-class serving counters for cache optimization and popularity analysis.

21. A non-transitory computer-readable medium storing instructions that, when executed by one or more processors, cause the processors to perform a method for contextual caching of large language model results, the method comprising:
(a) decomposing an input image associated with an LLM request into spatial regions and computing perceptual fingerprints for each region;
(b) searching a cache using priority-ordered cache key variants generated from stable uniqueness identifiers of a preceding workflow step, each variant resolved through an alias table;
(c) comparing per-region fingerprints against cached entries while skipping regions whose learned irrelevance scores meet or exceed a threshold;
(d) returning a cached LLM result upon match, or forwarding the request to an LLM upon cache miss;
(e) upon receiving a new LLM response, determining semantic equivalence with cached responses using tiered validation comprising a primary similarity scoring model and a secondary validation model for ambiguous scores; and
(f) when semantic equivalence is found with differing visual content, incrementing irrelevance scores on differing regions, thereby progressively learning which spatial regions are immaterial to the LLM response.

22. The non-transitory computer-readable medium of claim 21, wherein the stable uniqueness identifiers comprise a Canonicalized Answer Identifier derived from a deterministic hash of a normalized response representation and a Visual Screen Signature derived from a composite perceptual hash of the input image, and wherein after each cache interaction, the method returns the current step's identifiers for use by a subsequent workflow step, creating a resilient chain of cache references across multi-step workflows.

23. The non-transitory computer-readable medium of claim 21, wherein the method further comprises: maintaining exemplar composite fingerprints per cached response class for fast-path matching; supporting multiple output classes per cache key representing distinct valid responses; applying recursive type-aware field comparison for structured response data including semantic similarity for strings, tolerance-based comparison for numerics, and position-aware normalized coordinate matching for spatial values; and computing usage savings metrics comprising avoided token consumption, monetary cost, processing time, and environmental emissions upon each cache hit.
